(19) United States
(12) Patent Application Publication
(10) Pub. No.: US 2017/0023397 A1
(43) Pub. Date: Jan. 26, 2017

(54) i1-SCALE

(71) Applicant: Mark Belloni, Brewster, OH (US)

(72) Inventor: Mark Belloni, Brewster, OH (US)

(21) Appl. No.: 14/806,584

(22) Filed: Jul. 22, 2015

(51) Int. Cl. G01G 19/02

(52) U.S. Cl. CPC G01G 19/027

(57) ABSTRACT

il-Scale is capable of measuring all axle loads of semi-tractor trailers and other heavy duty vehicles. The electronic data is formatted into a certified electronic document that may be transmitted by wire or wireless to email, cell phone text message, and other telecommunication devices, facsimile, or printer for hard copy. The document includes: a time and date stamp, the time zone where the loads were measured, a GPS location of where the loads were measured, and a record of all axle loads and gross vehicle weight. The il-Scale is portable and may be used in a stationary environment. The il-Scale is comprised of a: light weight frame, piloted vertical stiffening plate, a detachable sensing element containing electro-mechanical or mechanical sensors, fasteners, a rechargeable battery pack, a bulkhead and access panels, and an on off switch. An auxiliary wire or wireless indicator light, with standalone battery pack, aids in axle alignment relative to the scale.

### CROSS REFERENCE FOR RELATED APPLICATIONS

Not Applicable

### STATEMENT REGARDING FEDERALLY SPONSORED RESEARCH AND DEVELOPMENT

Not Applicable

### FIELD OF INVENTION

The following description relates to a portable or stationary smart scale that is capable of electronically measuring, recording, and formatting static axle load data for transmitting a formatted certified document to a communication device, email, printer, or any other wire or wireless capable destination known to those of ordinary skill in the art using embedded programming technology. Along with the axle load data, a local time and date stamp when the axle loads were measured, and GPS coordinates where the axle loads were measured may also be transmitted. In addition, electro-mechanical variations of this capability may be configured to yield a real time axle load collection and monitoring system for the purpose of real time load optimization during the loading process of a semi-tractor trailer, large vehicle, truck, box, or any other shipping container known to those of ordinary skill in the art.

### BACKGROUND OF THE PRESENT INVENTION

Under some circumstances, the weight of each axle of a tractor-trailer, truck, heavy vehicle, or other transportation container, may need to be substantially determined before the vehicle exits the dock subsequent to the loading process. For example, after the loading of a trailer at a loading dock, the trailer may not have been loaded such that the loaded cargo is distributed among all axles optimally. Moreover, the distribution of the loaded cargo may be such that the limit load per axle is exceeded. In these situations, the driver most likely is unaware that this condition exists when exiting the dock. As a reassurance, the driver may desire to weigh each axle of the loaded vehicle substantially to ensure that the axles are not over loaded, and that the gross weight of the vehicle is within the allowable limit—before leaving the dock. Similarly, this same sort of load checking may be applied to other vehicles, trucks, heavy vehicles, transportation containers, containment structures, or any other means of transporting or containing goods in a manner known to those of ordinary skill in the art.

The axle load measurement data, made by the proposed il-Scale, may be recorded, stored, and sent electronically to a remote telecommunication device or other recording devices in the form of a certified secured electronic formatted output substantially. The measurement device and overall measurement system may be calibrated for accuracy in a manner that is traceable to certified national standards for weights and measures. For example, date and local time when the axle loads were measured substantially, the GPS location data where the axle loads were recorded substantially, the magnitude of each axle load, and the gross vehicle weight may be recorded electronically for the purpose of outputting certified weight measurements with time and location data as substantial legal documentation in an acceptable format as known to those of ordinary skill in the art.

If a trailer is not loaded properly—and one or more axle loads of the trailer are over the design limit—the trailer must return to the dock that it launched from to have the trailer reloaded such that each axle load is under the design limit. The truck driver, the trucking company, and the dock experience a substantial added cost involved due to the event of overloaded axles. In addition to the fine that the driver is faced with from the state highway patrol, or other authority, the return trip back to the dock, comes with costs. The obvious costs are: fuel, time, wear and tear on the vehicle; other higher order costs such as opportunity costs involved with accidents, driver fatigue, and other substantial costs known to those with ordinary skill in the industry also haunt the return trip back to the dock. Sometimes, the axle overload is not discovered for several hundred miles into the leg of the trip from the dock to the cargo destination. The greater the distance—the more amplified these cost are. Of course, the time penalty appears in many ways. The trip back to the dock and back to the point of turnaround, the time spent waiting to start the reload, the time to reload become substantial. The possible opportunity costs are enormous and are too cumbersome -to mention here; however, the phrase “doing that—while one should have been doing something else” attempts to describe the essence qualitatively. From a quantitative vantage point, the different outcome for each overload is negative, mainly. The associated penalty, relative to the dock, is the time to schedule a reload, the time to reload, and any schedule deviations required to accommodate the reloading of the overloaded trailer. Other costs not mentioned here and that are common knowledge to those of ordinary skill in the art are also part of the penalty. Hence, the need for a device, or set of devices, which minimizes substantially the event of an overloaded axle, overloaded axles, or overloaded gross vehicle weight.

Numerous patents exist which provide technology for determining axle loads of heavy vehicles; however, none were found to combine the recorded measurement data via embedded programming into a substantial formatted electronic certified document that contains the date, time and location of when and where the axle loads where recorded.

U.S. Pat. No. 6,122,600 (Sonderegger) uses a shear crystal to measure the shear force of an overrunning wheel in reference to verifying the functional efficiency of braking and ABS systems. The patent does not reference any wireless forms of communication to relay measurements to printers, cell phones or smart phones.

U.S. Pat. No. 5,995,888 (Hagenbuch) present an onboard apparatus for processing data from the weight of a load carried by a haulage vehicle, that combined with additional data provides a historical data base of vehicle operations. A wireless data transfer link is used with the device.

U.S. Pat. No. 5,742,914 (Hagenbuch) refers to an onboard pressure transducer for determining axle weight. A wireless data transfer link is sited in the patent.

U.S. Pat. No. 5,650,930 (Hagenbuch) refers to an onboard sensing apparatus and method for monitoring dynamically a load of material by means of an inclinometer or sensor which monitors the drive train. The data is time and date stamped for historic retrieval purposes. Downloading the time and date stamped weight data to a remote site via wireless data transfer link is also noted.

U.S. Pat. No. 5,650,928 (Hagenbuch) refers to 3 sensors for determining the amount of work a vehicle performs. Transmitters are used to communicate data to the onboard processor from the sensors onboard. The sensors detect: inclination, weight, and travel distance and vehicle location. The collected data may be used to dispatch vehicles and a means for material tracking, weight detection, and haulage condition.

U.S. Pat. No. 5,644,489 (Hagenbuch) reports the usage of a sensor—mounted to a vehicle—that detects a machine readable code for material identification. The vehicle includes a weighing device for determining material weight.

U.S. Pat. No. 5,631,835 (Hagenbuch) refers to an apparatus that retrieves a container code in conjunction with a loading event and senses the load increment then generates data indicative thereof. The recorded data is then further processed. A wireless data transfer link is also used.

U.S. Pat. No. 5,631,832 and U.S. Pat. No. 5,528,499 (Hagenbuch) report an onboard apparatus that processes weight load data carried by a haulage vehicle. A sensor processer unit detects load level changes for further manipulation. A wireless data transfer link is also used.

U.S. Pat. No. 5,528,499 (Hagenbuch) an apparatus for identifying containers. The apparatus includes an onboard weighing device for sensing the weight added to the vehicle and generating weight data for load history storage. A wireless data transfer link is also used.

U.S. Pat. No. 5,327,347 (Hagenbuch) discloses an apparatus that detects a change in load of a haulage vehicle. Data is received from a pressure transducer to establish a load history and further manipulation of the data. A wireless data transfer link is used also.

None of the references above disclose a device that measures and records the axle load data via embedded programming and creating a formatted electronic document that contains the time and location of when and where the axle loads where substantially measured, and recorded with the data outputted as a certified weight measurement

### SUMMARY OF THE INVENTION

The present invention is a device that determines the axle loads substantially of a semi-tractor trailer or heavy duty vehicle while the vehicle is in close proximity of the loading dock. The device system records substantially the steering axle load, drive axle load, and tandem axle load, retrieves substantially the local time and date just after the axle loads are measured, obtains substantially the GPS coordinates of the location where the axle loads were measured, formats substantially the data into a certified electronic document, then passes this information on to a communication device, laptop, notepad, or printer using wireless or wired technology via embedded programming techniques. An auxiliary indicator light set, that receives wireless or wired signals from the scale, may provide visual or audio indicators to the driver as a means to indicate the position of the axle relative to the sensing element substantially; and, is also a part of the proposed invention. To use the subject invention: in the preferred embodiment the driver places the portable scale just forward of the port and starboard tires attached to an axle that needs to be measured for static load. The driver sets the indicator light next to the portside scale such that the light display is visible to the driver from the cab of the tractor. After turning the scale on, the driver proceeds to slowly drive the wheels of the axle on top the scale substantially. The induced load imparted from the axle to the scale causes the vertical stiffening plate to contact the sensor element, which in turn, activates substantially the indicator lights to turn amber, then red. Once the red light is lit, the driver stops to allow the il-Scale to complete the load measurement; as, the sensor is activated and the axle load measurement is taken and recorded substantially. Once the measurement is complete, the green light on the indicator light strip becomes lit signalling the driver that he is now free to slowly move the tractor—trailer axle off of the scale. This process is repeated as many times that it takes to record all axle loads.

### DETAILED DISCUSSION OF THE PREFERRED EMBODIMENTS

FIG. 1 depicts substantially the overall mechanical configuration of the il-Scale. The side wall 008, the ramp 013, the platform 014, and the breakout edge of the stiffening plate edge 015, are substantially identified therein.

FIG. 2 shows the internal components of the il-Scale which are—for the most part—located substantially beneath both the platform 014 and the ramp 013. These components are representations of the nominal dimensions required to function under the massive load to be measured substantially. The aspect ratios of these components are realistic; while the thicknesses of these plate shapes are not provided. The 4 vertical stiffening plates 002 are shown. Note that there are 2 vertical stiffeners located substantially mid span relative to the platform and 2 vertical stiffeners located substantially on the perimeter of the platform. A typical side wall 008 is shown along with the bottom flange 017. The bulkhead 006 is not shown; however, it is centered substantially directly below the mid platform vertical stiffener 002.

FIG. 3 has 3 views of the il-Scale. The left ½ shows a substantial top view locating the ramp 013, vertical stiffeners 002, and the flange bottom 017. Section A-A is identified substantially in the top view too. This section details substantially the electro-mechanical design of the scale. Nominal dimensions are shown here as well. Although the il-Scale has 2 fold symmetry, the AFT and FWD ends are labeled notwithstanding. The top right portion of FIG. 3 is a front view AFT looking FWD. The overall height is detailed substantially along with the edge lines of the vertical stiffeners. The bottom right portion shows a close up side view of the FWD end where a platform 001 exists. A clearance is called out substantially for-discussion related to the load sensor.

FIG. 4 is a substantial elevation sketch from the cut section A-A in FIG. 3. The access panels 007 to the bulkhead fasteners are shown. The bulkhead 006 shown with the left and right ends hollowed out access to the fasteners 005 for detachment of the sensor element 003. Strain gages 004 mounted substantially to the sensor element can be seen there. Vertical pilots 011 on the exterior of the sensor element, provide for substantial contact guidance required for exiting the strain gages 004. The vertical stiffening plate 002 is shown as well. A section of the platform 001 may be seen there also. Cutting section B-B of section A-A is detailed there substantially. Note that the bulkhead and sensor element are not connected to the sidewalls 008 for functionality. The bulkhead is integral to the il-Scale floor.

FIG. 5 is an substantial elevation sketch from the cut section B-B in FIG. 4 . The access panels 007 to the bulkhead fasteners are shown. The bulkhead 006 shown with the left and right ends hollowed out access to the fasteners 005 for detachment of the sensor element 003. Strain gages 004 mounted substantially to the sensor element can be seen there. Vertical pilots 011 on the exterior of the sensor element, provide for contact guidance required for exciting the strain gages 004 substantially. The vertical stiffening plate 002 is shown as well. A section of the platform 001 may be seen there also. The design gap shown is there to let the bottom edge of the stiffener plate displace substantially during the loading process until the stiffener plate contacts substantially the piloted edge of the sensor element. The gap may be designed such that the majority of the axle load due to the heavy vehicle goes into closing the design gap substantially and the balance of the axle load goes into displacing the sensor element substantially causing strain to accumulate in the strain gage.

FIG. 6 is a substantial elevation sketch from the cut section A-A in FIG. 3. The access panels 007 to the bulkhead fasteners are shown. The bulkhead 006 shown with the left and right ends hollowed out access to the fasteners 005 for detachment of the sensor element 003. Eddy current probes 012 mounted substantially to the sensor element can be seen there. Vertical pilots 011 on the exterior of the sensor element, provide for contact guidance required for exiting the eddy current probe 012 substantially. The vertical stiffening plate 002 is shown as well. A section of the platform 001 may be seen there also. Cutting section B-B of section A-A is detailed there substantially. Note that the bulkhead and sensor element are not connected to the sidewalls 008 for functionality. The bulkhead is integral to the il-Scale floor

FIG. 7 is a substantial elevation sketch from the cut section B-B in FIG. 4. The access panels 007 to the bulkhead fasteners are shown. The bulkhead 006 shown with the left and right ends hollowed out access to the fasteners 005 for detachment of the sensor element 003. Eddy current probes 012 mounted substantially to the sensor element can be seen there. Vertical pilots 011 on the exterior of the sensor element, provide for contact guidance required for exiting the eddy current probe 012 substantially. The vertical stiffening plate 002 is shown as well. A section of the platform 001 may be seen there also. The design gap shown is there to let the bottom edge of the stiffener plate displace substantially during the loading process until the stiffener plate contacts the piloted edge of the sensor element. The gap may be designed such that the majority of the axle load due to the heavy vehicle goes into closing the design gap substantially and the balance of the axle load goes into displacing the sensor element causing excitation to the eddy current probe.

FIG. 8 shows the auxiliary indicator light strip 010. The signal coming from the il-Scale, may also be converted substantially into color coded display: yellow for mounting the scale, and red for stop to measure and record the axle load substantially, and green for the signal to dismount the scale.

FIG. 9 depicts another configuration of the il-Scale. The tube frame members 019, side rails 018, the ramp 013, the platform 014, and the vertical stiffening plates 002, are identified therein.

The il-Scale is retractable using a guide and slider arm. This mechanism—not shown—has several pin locations, along the forward and aft direction, for spacing the platforms depending on the service requirement. The guide may be a C-channel, square tubing, or any other section shape capable of allowing the translational degree of freedom along aft to forward while zeroing out the other translational and rotational degrees of freedom substantially.

Analysis shows that the linear strain field in a material body induced by any loading system is governed by the principal of superposition. This implies that the strain gage 004 sensors may be strategically placed onto the interior of the sensor element 003 such that the axle load and an over loaded axle may be monitored while strain gages remain within the recommended strain range.

Once the trailer is loaded with contents, the measured axle load data may be formatted into a document and sent wirelessly or in a wired manner to a cell phone, notepad, facsimile, printer, or other electronic message or other storage system know to those with ordinary skill in the art. The document may be of a certified, tamper proof, form detailing: the time and date that the measurement was made and the certified message was sent, the weight of the steering wheels, the weight of the drive axles, the weight of the tandem axles, and the GPS location that the measurement was taken. The signal from the analog output of the load sensors is converted to digital using an A/D circuit embedded in the device. The digitized output is marshaled and transmitted to the device destination via the embedded Bluetooth module. The cell phone application stores and processes the data, and using the built-in GPS sensor places the location and time of the sample into the database. The operator then has the option of printing or saving the scale values. The operator also has the ability to encrypt the data on the cell phone if desired. In an alternative embodiment the digitized output is processed within a wired, dedicated central processing unit, using an application that stores and processes the data and using a built in GPS sensor places the location and time of the measurements into memory for future access. The operator would have the option of printing or saving the data to a remote storage device or site.

The scale may be constructed from any metal alloy, synthetic, or composite material, or hybrid combinations thereof. Those versed in the state of the art would recognize that different shapes/configurations may be employed for minimizing material usage while maximizing the durability of the scale. At least two scales are needed to measure the weight of each set of wheels on the port side and starboard side of the trailer.

The scale may house some or all of the following: electronic hardware, the rechargeable battery pack and auxiliary electrical power port, the ON/OFF switch, a motherboard, a central processing unit, data storage and program memory, communications port, GPS unit, wireless communication module, various associated discrete components and the electronic wiring harness required for building the smart scale system. The housing, electronic hardware both remote and on board, application software both remote and onboard and scale support will compose an integrated configuration of the product.

### BRIEF DESCRIPTION OF THE DRAWINGS

The subject invention, associated features, usage, and enhancement of both tandem and steering axle weight may be better understood by referencing drawings 1 through 9.

FIG. 1 is an isometric of the subject invention, il-Scale; The ramps, platforms, side walls 008, and mid-plate vertical stiffener edge.

FIG. 2 shows the side wall, vertical-stiffeners, and bottom flange.

FIG. 3 shows 3 views of the subject invention. The plan view is in the left ½ shows the ramp, the stiffener edges, and the bottom flange. The front view—AFT looking FWD—is in the top right view that shows the side walls. The side view is in the lower right view showing the elevation view of the platform.

FIG. 4 is a view of section A-A depicted in FIG. 2. The component stack-up of the access panels, bulkhead, fasteners, detachable sensing element—and strain gage, pilot features, vertical stiffeners and platform plate are shown. Cutting section B-B is also shown.

FIG. 5 is a view of section B-B depicted in FIG. 3. A side view of the access panels, bulkhead, fasteners, detachable sensing element and strain gages, pilot features, vertical stiffeners and platform plate are shown, with the design gap detailed and the bulkhead cutout required for detaching the sensing element.

FIG. 6 is a view of section A-A depicted in FIG. 2. The component stack-up of the access panels, bulkhead, fasteners, detachable sensing element—and eddy probe, pilot features, vertical stiffeners and platform plate are shown. Cutting section C-C is also shown.

FIG. 7 is a view of section C-C depicted in FIG. 5. A side view of the access panels, bulkhead, fasteners, detachable sensing element and eddy current probe, pilot features, vertical stiffeners and platform plate are shown, with the design gap detailed and the bulkhead cutout required for detaching the sensing element.

FIG. 8 is a view FWD looking AFT of the il-Scale and indicator light operated by wire or wireless.

FIG. 9 is a possible light weight configuration showing the vertical stiffeners, ramp, and platform, side rails, tube frame member.

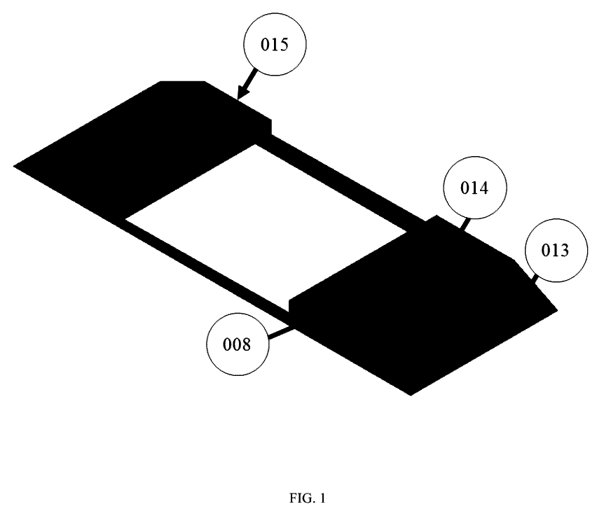

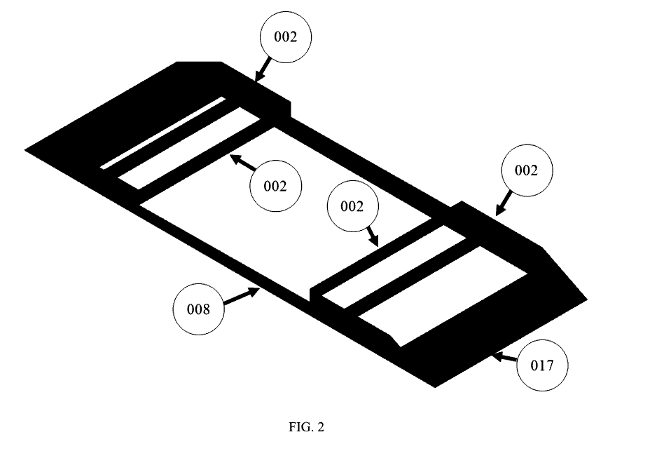

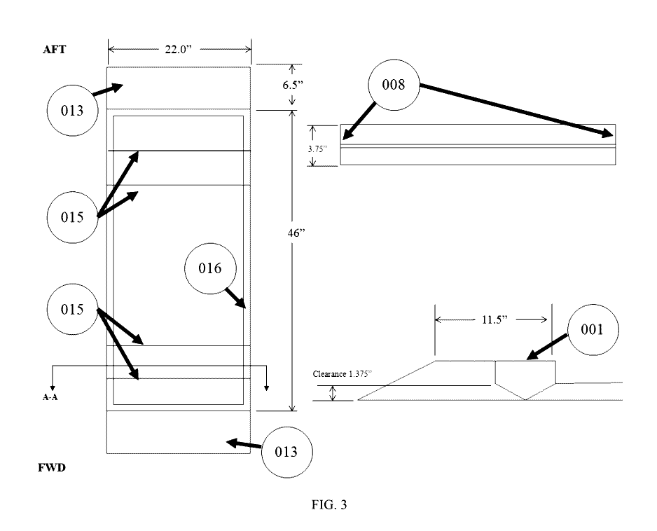

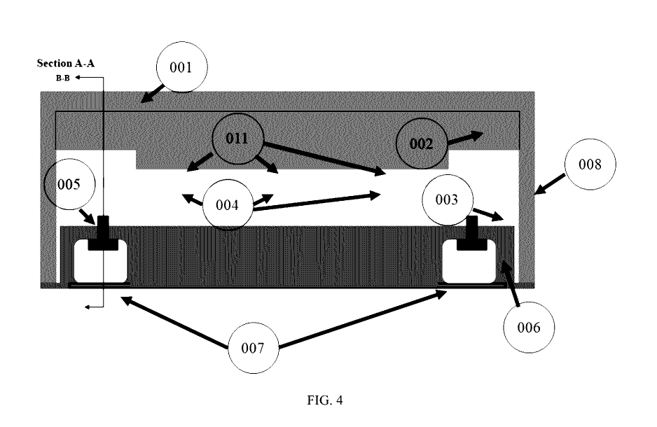

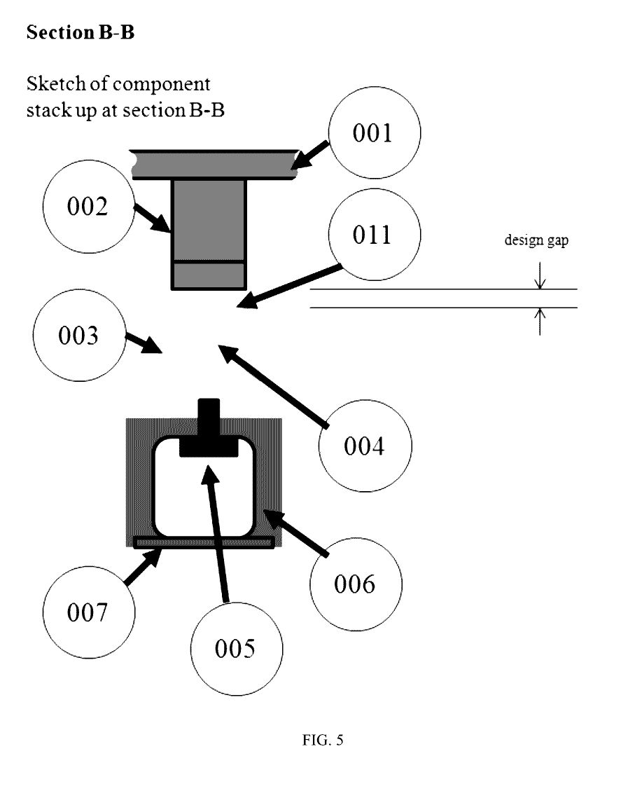

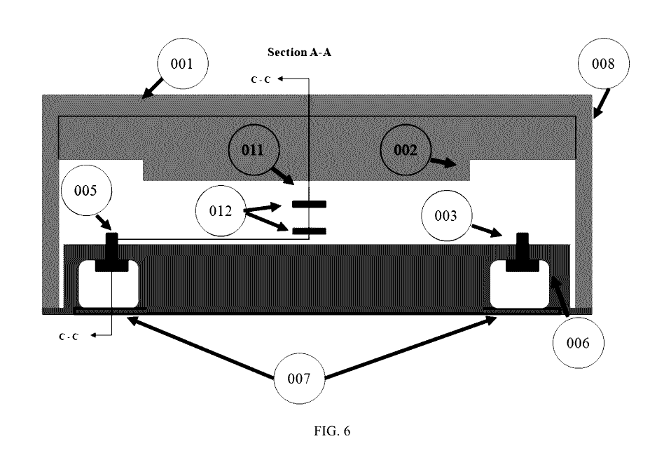

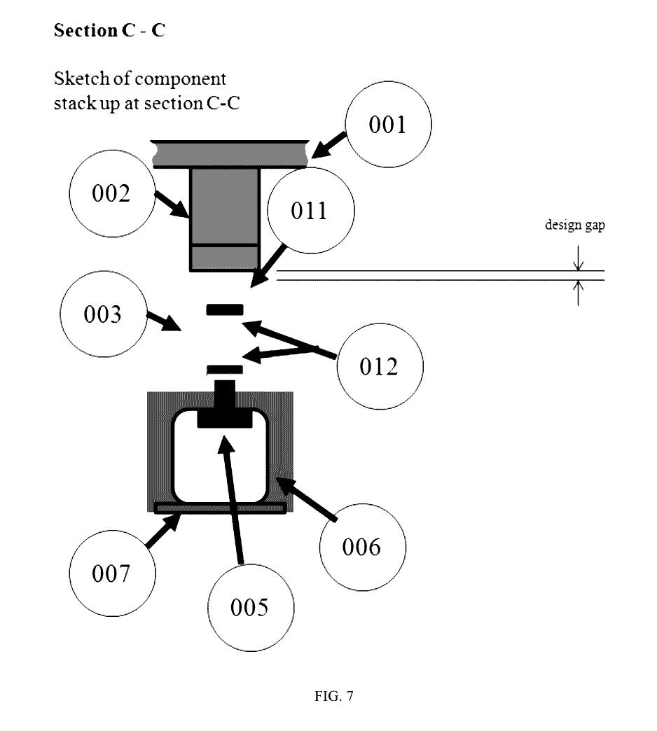

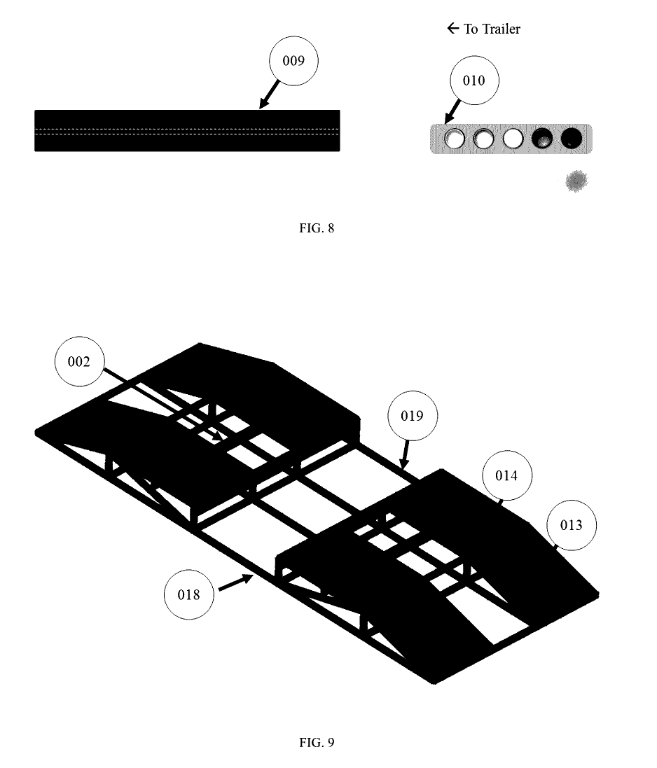

### DRAWING REFERENCE NUMBERS

001 Platform Elevation View
002 Vertical Stiffener
003 Detachable Sensing Element Unit
004 Strain Gages
005 Fasteners
006 Bulkhead With Stiffeners
007 Access Panels
008 Side Wall
009 il-Scale
010 Indicator Light Strip
011 Contact Pilots
012 Eddy Current Probe
013 Ramp
014 Platform
015 Stiffener Edge
016 Bottom Flange
017 Side Rail
018 Tube Frame Member

I claim:

1. The electro-mechanical design and methods for axle load measuring, certification, and displaying axle weight data for transportation vehicles and transportation containers as it applies to the il-Scale. Said electro-mechanical design includes: shaped components, piloted features, materials, configurations, sensors and sensor elements. Said term certification means that the measured weight is traceable to standards set by local or global governing authorities. Said term display includes the measured axle weight quantity, the date, the time and time zone when the axle weight was measured, and the location of where the axle weight was measured. Said shaped components include but are not limited to pluralities of: tubular section designs and stiffeners of circular, elliptical, square, rectangular, oval, and triangular sections and truncations thereof. Said section designs may be hollow or solid, plates and shells of any developed surface with or without lightening holes with uniform, tapered, or stepped thickness prescriptions and pluralities thereof. The assemblage of said shaped components may be such that the system is retractable, along the forward and aft direction and perpendicular to that, using guided collars and linkages—and any other retracting mechanism know to those of ordinary skill in the art. Said retractable mechanism may have pin and hole settings, and pluralities thereof, for sizing platform distance along the forward and aft direction substantially. Said piloted features may span the whole length of the sensing element or may pilot the vertical stiffening plate to the sensor element in 1, 2, 3 or a plurality of contact locations. Said piloted features may be shaped as but not limited to a plurality of: bumps, ridges, flats, rounds or any other shape known to those of ordinary skill in the art. Said features may have any possible associated dimensions. Said materials may be aluminum, alloys, steel, and composites: metal matrix or epoxy or other material combinations and—or—a plurality of hybrid combinations of said materials. Said sensors may be purely mechanical or electro-mechanical in nature. Said sensors may be a plurality mounted in any orientation in order to measure the axle loads; and may be detachable for calibration and or replacement. Said sensors may be housed in any shaped containment including but not limited to the following primitive shapes: spheroids, ellipsoids, trapezoids, triangular forms, pseudo-circular, pseudo-ellipsoids and combinations thereof in plurality. Said sensors may be tamper resistant. Said shaped containments may be made of any material such as but not limited to aluminum, aluminum alloys, composites and hybrid combinations thereof in plurality—or—may be discarded from the configuration with the electronic sensors mounted directly to the frame or stiffening plate. Adhesives, coatings, plating, and other manufacturing enhancements for the mechanical design of this invention also are claimed under the electro-mechanical design of the il-Scale.
A routine for calculating the optimal location of the individual pallets on a container floor. Said routine depends on, but is not limited to: pallet load from sensors, center of mass coordinates of material on pallet, and container geometry. Said routine may be an algorithm programmed into the measurement system central processing unit with the aim of optimizing substantially where the pallet load should be placed to minimize the unbalance of the total payload. Output of said routine may be relayed to the fork truck operator by audio or a display screen identifying where the pallet load should be place on the floor of the container. Said sensors 0001 may be mechanical, electronic, or electro-mechanical. Usage of shallow inclines in combination with stationary or portable scales such as the preferred embodiment and other techniques known to those of ordinary skill in the art are essential to the calculation of center of gravity coordinates. The overall center of gravity of the loaded container can be determined with the same approach. Said routine may leverage stochastic methods and statistical processes along with a plurality of sensors and inclines sufficient to accurately determine weight distribution along the length of said transportation vehicles and said transportation containers. Said stochastic methods used in optimizing the pallet locations may be those which model random processes: discrete time, continuous time, both discrete and continuous time, fields and other modeling schemes, time series models, queuing models, and other known models to those skilled in the art.
A method for weighing, certifying, and displaying weigh data for transportation vehicles and transportation containers. Said method is a plurality of weighing devices sufficient to accurately determine weight distribution along the length of said transportation vehicles and said transportation containers where said weighing devices are analog or digital devices.
A plurality of data transmission devices connected by wire or wireless to said weighing devices 0003
A means of data collection from each said data transmission device 0004. Said data collection is electronically stored.
A means of data computation on data from said data collection 0005 means.
The data computation of claim 0006 wherein said data computation is done by electronic computation
A means of displaying results to a machine or human electronically or by hardcopy, whereby, a human or machine can weigh transportation vehicles or transportation containers and receive accurate information on weight.
